(19) United States
(12) Patent Application Publication
(10) Pub. No.: US 2013/0179491 A1
(43) Pub. Date: Jul. 11, 2013

(54) ACCESS CONTROLS FOR COMMUNICATION SESSIONS

(71) Applicants: David Scrymgeour Bennett, Issaquah, WA (US); Chee H. Chew, Redmond, WA (US); Eduardo Fernandez, Bothell, WA (US); Loren Michael Groves, Sunnyvale, CA (US); Christopher Paul David Johnson, San Bruno, CA (US); Nikhyl David Singhal, Menlo Park, CA (US); Brian David Marsh, Seattle, WA (US); William Kuo-Wei Wen, Renton, WA (US)

(72) Inventors: David Scrymgeour Bennett, Issaquah, WA (US); Chee H. Chew, Redmond, WA (US); Eduardo Fernandez, Bothell, WA (US); Loren Michael Groves, Sunnyvale, CA (US); Christopher Paul David Johnson, San Bruno, CA (US); Nikhyl David Singhal, Menlo Park, CA (US); Brian David Marsh, Seattle, WA (US); William Kuo-Wei Wen, Renton, WA (US)

(73) Assignee: GOOGLE INC., Mountain View, CA (US)

(21) Appl. No.: 13/371,255

(22) Filed: Feb. 10, 2012

Related U.S. Application Data
(60) Provisional application No. 61/585,626, filed on Jan. 11, 2012.

(51) Int. Cl. G06F 15/16

(52) U.S. Cl. 709/203

(57) ABSTRACT

Aspects of the present disclosure may provide techniques that enable a first user participating in a real-time communication session to choose whether to communicate with a second user that joins the real-time communication session. In one example, a method includes sending a plurality of video feeds for display at a plurality of graphical user interfaces (GUIs) of client devices coupled to a real-time communication session. The method also includes receiving a request from a first client computing device to couple to the real-time communication session, wherein a first user is associated with the first client device. The method also includes determining whether to enable communication using the real-time communication session between the first user and a second user associated with a second client device coupled to the real-time communication session.

### CROSS REFERENCE TO RELATED APPLICATIONS

This application claims the benefit of U.S. Provisional Application No. 61/585,626, filed Jan. 11, 2012, the entire content of which is hereby incorporated by reference.

### TECHNICAL FIELD

The disclosure relates to communication over a network and, more specifically, to users communicating over a network.

### BACKGROUND

Multiple users of computing devices may engage in real-time video communications, such as video conferencing, where the users exchange live video and audio transmissions. In some examples, visual representations of the users may be shared with each user engaged in real-time video communications. Each computing device associated with a user may include a client that enables the real-time video communication. In some instances, the client may include a graphical interface that displays the visual representations of each of the users.

### SUMMARY

In one example, a method may include sending, by a computing device, a plurality of video feeds for display at a plurality of graphical user interfaces (GUIs) of client devices coupled to a real-time communication session. The real-time communication session may enable communication among a plurality of users associated with the client devices and at least one of the plurality of video feeds may comprise a visual representation of user participation in the real-time communication session. The method may include receiving, by the computing device, a request from a first client device to couple to the real-time communication session, wherein a first user is associated with the first client device. The method may include determining, by the computing device, whether to enable communication using the real-time communication session between the first user and a second user associated with a second client device coupled to the real-time communication session, in response to receiving the request.

In one example, a computer-readable storage medium may include instructions that, when executed, cause one or more processors to perform operations including, sending a plurality of video feeds for display at a plurality of graphical user interfaces (GUIs) of client devices coupled to a real-time communication session. The real-time communication session may enable communication among a plurality of users associated with the client devices, and at least one of the plurality of video feeds may comprise a visual representation of user participation in the real-time communication session. The computer-readable storage medium may include instructions that, when executed, cause one or more processors to perform operations including receiving a request from a first client device to couple to the real-time communication session. The first user may be associated with the first client device. The computer-readable storage medium may include instructions that, when executed, cause one or more processors to perform operations including determining whether to enable communication using the real-time communication session between the first user and a second user associated with a second client device coupled to the real-time communication session, in response to receiving the request.

In one example, a computing device may include one or more processors. The computing device may include a server module executable by the one or more processors to send a plurality of video feeds for display at a plurality of graphical user interfaces (GUIs) of client devices coupled to a real-time communication session. The real-time communication session may enable communication among a plurality of users associated with the client devices, and at least one of the plurality of video feeds may include a visual representation of user participation in the real-time communication session. The server module may be executable by the one or more processors to receive a request from a first client device to couple to the real-time communication session, wherein a first user is associated with the first client device. The server module may be executable by the one or more processors to determine, in response to receiving the request, whether to enable communication using the real-time communication session between the first user and a second user associated with a second client device coupled to the real-time communication session.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of one or more client devices connected to a real-time communication session that enables communication among users, in accordance with one or more aspects of the present disclosure.

FIG. 2 is a block diagram illustrating further details of one example of a computing device shown in FIG. 1, in accordance with one or more aspects of the present disclosure.

FIG. 3 is a flow diagram illustrating example operations of a computing device that may enable a second user participating in a real-time communication session to choose whether to communicate with a first user that joins the real-time communication session, in accordance with one or more aspects of this disclosure.

FIG. 4 is a diagram illustrating one example of a graphical user interface of a communication client, in accordance with one or more aspects of the present disclosure.

FIG. 5 is a flow diagram illustrating example operations of a computing device that may enable a second user participating in a real-time communication session to choose whether to communicate with a first user that joins the real-time communication session, in accordance with one or more aspects of this disclosure.

### DETAILED DESCRIPTION

Overview

Friends, family members, or other individuals who wish to socialize or otherwise communicate may not always be in the same physical location at the time that they would like to communicate. Some individuals may rely upon telephonic, text, or other forms of communication that support limited forms of socializing. For example, conventional forms of communication may support multi-way audio and/or video communication. However, some forms of communication are not sufficient to be able to give the individuals an experience similar to actually socializing in person. Talking with someone over the phone or texting someone does not create a shared experience similar to sitting a room together watching a movie or playing a game.

Rather than interacting together in the same physical location, techniques of this disclosure may, in various instances, provide a mechanism for two or more individuals to socialize in the same virtual location. In some examples, the virtual location may be referred to as a “hangout” or real-time communication session. For instance, a real-time communication session may be a virtual space where multiple users can engage in a conversation and/or share information. The individuals participating in the real-time communication session may share and watch videos, play games, participate in video, audio, or text chat, surf the web, or any combination thereof. In other words, a real-time communication session may mirror the experience of individuals hanging out in the same physical location.

In some instances, users may wish to control who they communicate with in a real-time communication session. For instance, a first user may wish to refrain from speaking with and/or viewing a second user in a real-time communication session. In some examples, the first user may also wish to prevent the second user in the real-time communication session from receiving audio and/or video data from the first user. Techniques of the present disclosure may enable users to granularly control which users they communicate with in a real-time communication session. In some examples, techniques of the disclosure may notify users of new participants who join a real-time communication session and allow users to leave the real-time communication session if they choose. In this way, techniques of the disclosure may improve user security and user privacy. Such techniques may improve user security and user privacy in a transparent and intuitive manner thereby enhancing the user experience when communicating using a real-time communication session.

In one example, multiple communication clients may each be coupled to a real-time communication session that is managed by a communication server. Each communication client may be executing at a client device that is associated with a user communicating via the real-time communication session. A subsequent user may wish to join the real-time communication session and, consequently, may provide a user input to a communication client that causes the communication client to send a request to the communication server to join the real-time communication session. The communication server may receive the request from the communication client and determine whether to enable communication between the subsequent user and one or more users communicating using the real-time communication session. Various techniques described in this disclosure enable the communication server to determine whether the subsequent user may communicate with one or more users communicating via the real-time communication session.

As used throughout this disclosure, headings are included to improve the clarity of the disclosure and are not used to define separate embodiments. In some examples, features of various embodiments may be combined and/or used from among multiple headings in accordance with aspects of the present disclosure.

### EXAMPLE SYSTEM

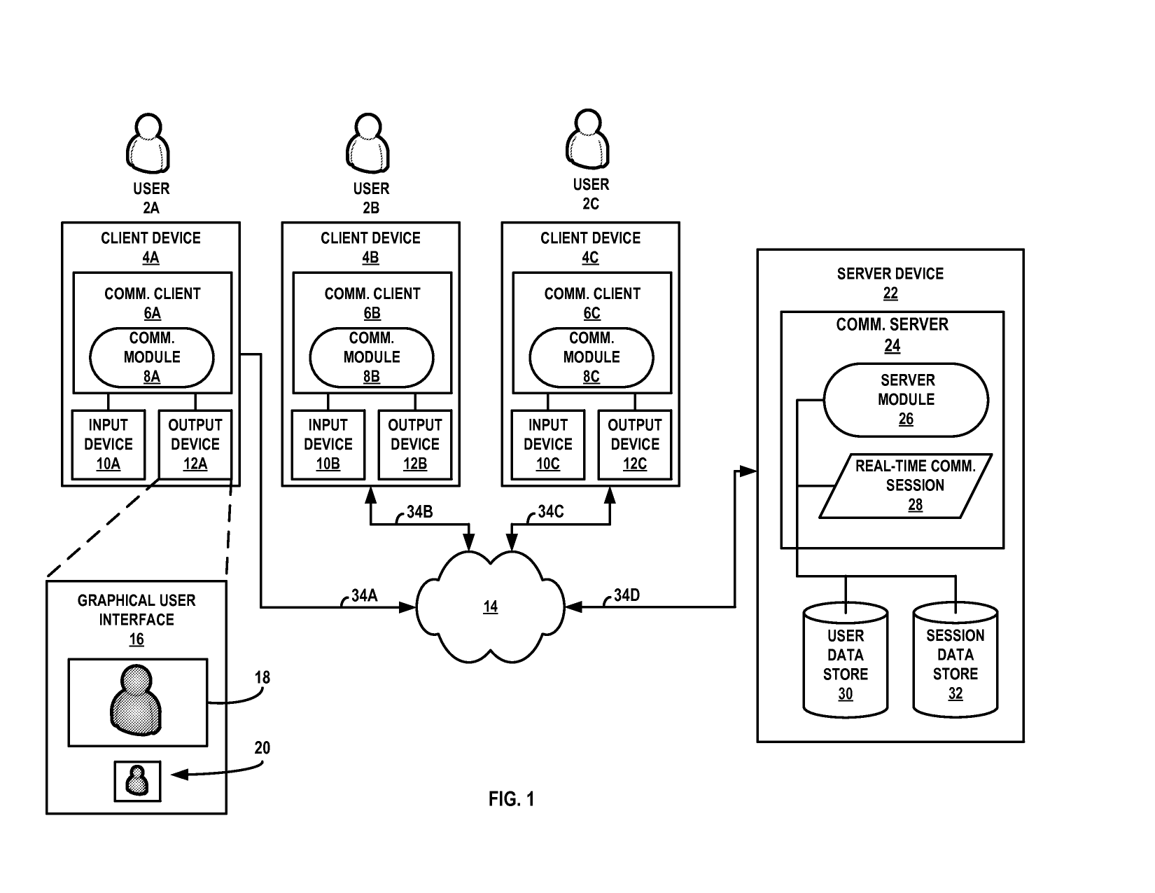

FIG. 1 is a block diagram illustrating an example of one or more client devices connected to a real-time communication session that enables communication among users, in accordance with one or more aspects of the present disclosure. FIG. 1 includes client devices 4A-4C (collectively referred to as “client devices 4”) and server device 22, which may be connected by network 14. Each for client devices 4 may be associated with users 2A-C, respectively. Client devices 4 include input devices 10A-10C, output device 12A-12C, and communication clients 6A-6C, which further include communication modules 8A-8C.

As shown in FIG. 1, server device 22 includes communication server 24, server module 26, and real-time communication session 28. Server device 22 may also include user datastore 30 and session datastore 32. Each of client devices 4 and server device 22 may be connected by communication channels 34A-D, which in some examples may be wired or wireless communication channels capable of sending and receiving data. One example of communication channels 34 may include a Transmission Control Protocol/Internet Protocol (TCP/IP) network connection.

Client devices 4 may be communicatively coupled to a real-time communication session 28 that enables communication among users of client devices 4, in accordance with one or more aspects of the present disclosure. Examples of client devices 4, may include, but are not limited to, portable or mobile devices such as mobile phones (including smart phones), laptop computers, personal digital assistants (PDAs), portable gaming devices, portable media players, e-book readers, and televisions with one or more processors embedded therein or attached thereto. Client devices 4 may be the same or different types of devices. For example, client devices 4A-4C may each be mobile phones. In another example, client device 4A may be a mobile phone, client device 4B may be a desktop computer, and client device 4C may be a tablet computer.

Client devices 4 may include one or more input devices 10A-10C. Input devices 10A-10C may include keyboards, pointing devices, microphones, and cameras capable of recording one or more images or video. Client devices 4 may also include output devices 12A-C. Examples of output devices 12A-C may include a video graphics card, computer display, sound card, and speakers.

Client devices 4 of FIG. 1 may include communication clients 6A-C (collectively referred to as “communication clients 6”). Communication clients 6 may each provide similar or the same functionality. In other examples, communication clients 6 may each include different functionality. Communication clients 6 may include mobile or desktop computer applications that provide functionality described herein. In some examples, communication clients 6 may include communication modules such as communication modules 8A-C as shown in communication clients 6, respectively. Communication clients 6 may exchange audio, video, text, or other information with other communication clients connected to real-time communication session 28.

Communication modules 8A-8C may cause output devices 12A-C to display graphical user interfaces. For instance, communication module 8A may cause output device 12A to display graphical user interface (GUI) 16. Communication modules 8A-C may further include functionality that enables communication clients 6 to couple to communication server 24 and join one or more communication sessions, such as communication session 28. Two or more client devices (e.g., client device 4A and client device 4B) may couple to the same communication session 28 thereby enabling users 2A and 2B to communicate using client devices 4A, 4B and real-time communication session 28.

GUI 16 may include graphical elements such as video feeds 18 and 20. In one example, input device 10A may generate a visual representation of user 2A. A visual representation may be a still image or group of images (e.g., a video). Communication module 8A may cause output device 12A to display video feed 18, which includes a visual representation of user 2A. Communication module 8A may also send the visual representation to communication server 24, which may determine that communication client 6B is connected to real-time communication session 28. Consequently, server module 26 may send the visual representation of user 2A to communication client 6B as a video feed. Communication module 8B may, upon receiving the visual representation, cause output device 12B of client devices display the video feed. Communication client 6A may similarly receive a video feed that includes visual representations of user 2B. The video feed of user 2B may be included in GUI 16 as video feed 20. In some examples, GUI 16 includes a video feed of one or more users participating in real-time communication session 28.

In addition to exchanging video information, communication clients 6 may exchange audio, text and other information via real-time communication session 28. For instance, microphones may capture sound at or near each of client devices 4, for example, voices of users 2A-2C. Audio data generated from the sound by client devices 4, may be exchanged between communication clients 6 connected to real-time communication session 28. For instance, if user 2A speaks, input device 10A may receive the sound and convert it to audio data. Communication module 8A may then send the audio data to communication server 24. Server module 26 may determine communication client 6B is connected to real-time communication session 28. Upon determining that communication client 6B is connected to real-time communication session 28, communication server 24 sends the audio data to communication client 6B. In still other examples, text such a real-time instant messages or files may be exchanged between communication clients 6 using similar techniques.

As shown in FIG. 1, server device 22 includes communication server 24, server module 26, and real-time communication session 28. Examples of server device 22 may include a personal computer, a laptop computer, a handheld computer, a workstation, a data storage system, a supercomputer, or a mainframe computer. Communication server 24 may generate, manage, and terminate communication sessions such as real-time communication session 28. In some examples, communication server 24 is an application executing on server device 22 that performs operations described herein.

In one example, server module 26 of communication server 24 may receive a request to generate real-time communication session 28. For instance, communication client 6A may send a request to communication server 24 that causes server module 26 to generate real-time communication session 28. Upon generating real-time communication session 28, other communication clients such as communication clients 6B and 6C may also connect to real-time communication session 28. For instance, user 2A may provide a user input at input device 10A that causes communication module 8A to send invitations to client devices 4B and 4C. Upon receiving the invitations, users 2B and 2C may provide user inputs that cause communication modules 8B and 8C to send requests to communication server 24 to join real-time communication session 28. Server module 26, upon receiving the requests, may connect communication clients 6B and 6C to real-time communication session 28. In other examples, users 2B and 2C may discover real-time communication session 28 by browsing a feed that includes an indicator identifying real-time communication session 28. Users 2B and 2C may join real-time communication session 28 by providing user inputs that cause communication modules 8B and 8C to send requests to communication server 24.

Real-time communication session 28 may enable communication clients 6 connected to real-time communication session 28 to exchange information. As such, a real-time communication session as used herein is a broad term encompassing as its plain and ordinary meaning, including but not limited to, a virtual space where multiple users can engage in a conversation and/or share information. In some examples, the virtual space may be implemented using one or more objects, which may be stored in and/or are executable by software or hardware. Communication session 28 may include data that, among other things, specifies communication clients connected to communication session 28. Communication session 28 may further include session information such as a duration of the communication session, security settings of the communication session, and any other information that specifies a configuration of the communication session. Server module 26 may send and receive information from communication clients connected to communication session 28 thereby enabling users participating in the communication session to exchange information.

As shown in FIG. 1, server device may further include user datastore 30 and session datastore 32. User datastore 30 and session datastore 32 may include any suitable data structure to store information such as a database, lookup table, array, linked list, etc. In some examples, user datastore 30 stores information associated with each user that may communicate using real-time communication session 28. For instance, user datastore 30 may include profile information associated with each user. Profile information may include one or more attributes associated with the first user. Examples of profile information may include interests, groups, activities, pictures, applications, and/or any other information associated with a user. Other examples of profile information include a user's first name, last name, email address, phone number, home or work address, and/or globally unique identifier.

User datastore 30 may further include indications of relationships that exist between users. For instance, user datastore 30 may store information that indicates a social network of each user that may participate in real-time communication session 28. For instance, user datastore 30 may include information that indicates user 2B is included in user 2A's social network. In such examples, a relationship may be said to exist between user 2A and 2B when user 2B is included in user 2A's social network.

Session datastore 32 may store information about each real-time communication session that is managed by communication server 24. In this way, communication server 24 may manage multiple real-time communication sessions. For instance, session datastore 32 may store data that, among other things, specifies communication clients connected to real-time communication sessions. Session datastore 32 may further store session information such as durations of the real-time communication sessions, security settings of the real-time communication sessions, and any other information used to configure and/or maintain status of real-time communication sessions.

In accordance with aspects of the present disclosure, server module 26 may perform one or more techniques to enable users to granularly control which users they communicate with in a real-time communication session. In some examples, real-time communication sessions may be public real-time communication sessions or privacy-controlled real-time communication sessions. A public real-time communications session may be a real-time communication session that enables any user to join to the session and communicate with other users in the real-time communication session. In contrast, a privacy-controlled real-time communication session may be configured to implement one or more techniques of the present disclosure. Generally, a privacy-controlled real-time communication session may be a real-time communication session that enables users to granularly control which users they communicate with in the session. A real-time communication session may be configured as privacy-controlled or public when the session is created and/or at later time while users are communicating using the session.

As shown in FIG. 1, user 2A and user 2B may each be associated with client devices 4A and 4B, respectively. Each of communication clients 6A and 6B may be coupled to real-time communication session 28 via network 14. In the current example, real-time communication session 28 may be configured as a privacy-controlled real-time communication session. As shown in FIG. 1, communication module 8A may cause GUI 16 to include video feed 18, which may include a visual representation of user 2A's participation in real-time communication session 28. Communication module 8A may further cause GUI 16 to include video feed 20, which may include a visual representation of user 2B's participation in real-time communication session 28. Each of video feeds 18 and 20 may be sent by communication server 24, which manages real-time communication session 28.

In one example, user 2C may wish to communicate with users 2A and 2B using real-time communication session 28. User 2C may initially provide a user input at input device 10C that causes communication module 8C to send a request to communication server 24 to couple communication client 6C to real-time communication session 28. The request may include a user identifier that identifies user 4A and a session identifier that identifies real-time communication session 28. As described throughout this disclosure, when a communication client is coupled to a real-time communication session, the client device executing the communication client may further be described being coupled to the real-time communication session.

The request sent by communication module 8C may be initially received by server module 26 of communication server 24. In response to receiving the request, server module 26 may determine whether to enable communication using real-time communication 28 between users 2A and 2B. For purposes of illustration, some techniques of the disclosure may be illustrated using user 2A; however, server module 26 may apply such techniques to any number of users communicating using real-time communication 28. Enabling communication using real-time communication between two users may include server module 26 sending video and/or audio streams of each user to the other user.

To determine whether to enable communication using real-time communication 28 between user 2C and users 2A and 2B, server module 26 may query user datastore 30 to select profile information associated with user 2C. For instance, communication module 8C may use the user identifier included the request from communication module 8C to select the profile information. In some examples, the profile information associated with user 2C includes one or more attributes associated with user 2C. Upon selecting the profile information, server module 26 may determine that communication clients 6A and 6B are each coupled to real-time communication session 28. Consequently, server module 26 may send the profile information associated with user 2C to communication clients 6A and 6B that are each coupled to real-time communication session 28.

To determine whether to enable communication using real-time communication 28 between user 2C and users 2A and 2B, server module 26 may also query user datastore 20 to determine whether relationships exist between user 2C and users 2A and 2B. For instance, as described herein, user datastore 30 may store information about social networks of users 2A and 2B. In one example, user datastore 30 may store a unique user identifier for each user. Using the user identifier included in the request from communication module 8C, server module 26 may determine, for example, whether user 2C is included in social networks of user 2A and/or user 2B. Server module 26 may send relationship information that includes indications of relationships between user 2C and users 2A and/or 2B to communication clients 6A and 6B.

In some examples, communication clients 6A and 6B may initially receive the profile information and/or relationship information from server module 26. Communication modules 8A and 8B may cause output devices 12A and 12B to display the profile information and/or relationship information associated with user 2C. In this way, users 2A and 2B may determine the identity of user 2C and, in some examples, evaluate relationships between user 2C and users currently communicating using real-time communication session 28, such as users 2A and 2B. Communication modules 8A and 8B may further cause output devices 12A and 12B to display one or more user interface components (e.g., hyperlinks, control buttons, etc.) that enable users 2A and 2B to select whether user 2C is allowed to communicate using real-time communication session 28.

In some examples, users 2A and 2B may provide user inputs to select whether user 2C is allowed to communicate using real-time communication session 28. For instance, user 2A may provide a user input to select a user interface component included in GUI 16. The user interface component, when selected, may cause communication module 8A to generate an indication that indicates whether user 2C is allowed to communicate using real-time communication session 28. Each of communication modules 8A and 8B, upon generating such indication in response to user inputs from users 2A and 2B, may send the indications to server module 26.

Server module 26 may initially receive the indications from communication modules 8A and 8B. In some examples, server module 26 may determine a quantity of indicators that indicate user 2C is not allowed to communicate using real-time communication session 28. Server module 26 may determine, for example, whether a quantity of indicators that indicate user 2C is not allowed to communicate using real-time communication session 28 is greater than a defined value. The defined value may be user defined or determined by server module 26. For instance, a defined value determined by server module 26 may be a quantity equal to half of the quantity of users communicating using real-time communication session 28.

When the quantity of indicators that indicate user 2C is not allowed to communicate using real-time communication session 28 is greater than the defined value (e.g., a value equal to half of the quantity of users communicating using real-time communication session 28), server module 26 may deny communication client 6C from coupling to real-time communication session 28. Thus, the example technique as previously described may enable users communicating using real-time communication session 28 to deny or allow another user to join real-time communication session 28 by majority vote. That is, users communicating using real-time communication session 28 may control whether other users are permitted to join real-time communication session 28 through a voting process. Although the current example illustrates a technique using majority vote, any technique for polling of indications from users to allow or deny another user from communicating in real-time communication session 28 may implemented by server module 26.

Similar techniques may be implemented by server module 26 to expel a user that is already communicating using real-time communication session 28. For instance, user 2A may provide a user input that causes communication module 8A to send a request to server module 26 to poll other users communicating using real-time communication session 28 whether another user should be expelled from real-time communication session 28 (e.g., the communication client associated with the user is decoupled from real-time communication session 28). In such example, server module 26 may send messages to communication clients of each user coupled to real-time communication server 28 that indicate the user to be expelled. Each user may provide a user input which causes communication modules to generate indications indicating whether the user in question should be expelled. The communication modules may send the indications to server module 26, which may determine whether to decouple the client device of the user in question. Server module 26 may similarly apply a majority vote technique or any other technique as described herein to determine whether to decouple the client device. Based on the technique applied, server module 26 may decouple the communication client from real-time communication session 28 using the indications from other users communicating using real-time communication session 28.

In another example, techniques of the present disclosure may enable one or more users to act as moderators of real-time communication session 28. For instance, user 2A may be associated with an attribute that enables user 2A to deny communication client 6C from coupling to the real-time communication session 28. An attribute may indicate that user 2A is associated with a privilege or authority to deny communication clients from coupling to real-time communication session 28. An attribute may, in some examples, indicate that user 2A may cause server module 26 to decouple a communication client that is already coupled to real-time communication session 28.

In one example, user 2A may provide a user input at input device 10A that causes communication module 8A to generate an indication that indicates whether user 2C is allowed to communicate using real-time communication 28. User 2A may provide such user input when user 2C initially attempts to join real-time communication session 28 or when communication client 6C is already coupled to real-time communication session 28. Communication module 8A may send the indication to server module 26. A user identifier that identifies user 2A may also be sent to server module 26.

Server module 26 may determine, using the identifier that identifies user 2A, whether user 2A is associated with an attribute that enables user 2A to deny communication client 6C from coupling to real-time communication 28, or in other examples, decouple communication client 6C from real-time communication 28. In some examples, the attribute associated with user 2A may be stored in user datastore 30 associated with profile information of user 2A. In other examples, the attribute may be stored in session datastore 32 and associated with real-time communication session 28.

In any case, when user 2A is associated with such an attribute, server module 26 may determine whether the indication indicates whether communication client 6A may be decoupled or denied from coupling to real-time communication session 28. When the indication indicates communication client 6A is to be decoupled or denied from coupling to real-time communication session 28, server module may decouple or deny server module 26 from coupling to real-time communication session 28.

In some examples, multiple users may attempt to join real-time communication session 28. In such examples, communication modules executing on client devices of each user attempting to join real-time communication session 28 may generate requests that are sent to server module 26. Server module 26 may receive the requests and queue the requests in the order in which the requests are received by server module 26. Server module 26 may subsequently send indications that indicate the requests to each communication module currently coupled to real-time communication session 2. In some examples, the indications may be sent in the order in which the requests have been queued by server module 26. For each indication sent, server module 26 may send relationship and/or user profile information associated the user that generated the queued request.

When the indications of the requests are received at, for example, communication module 8A, communication module 8A may cause output device 12A to display each indication in sequential order as the indications are received. In this way, user 2A may evaluate each indication of a request in the order it was received by server 26. Thus, for each indication of a request displayed to user 2A by output device 12A, user 2A may provide a user input to generate an indication whether the user is allowed to join real-time communication session 28. The indication may be then be sent to server module 26, which may apply the techniques as described herein (e.g., majority vote, etc.).

Techniques of the present disclosure may improve user security and user privacy in a transparent and intuitive manner thereby enhancing the user experience when communicating using a real-time communication session. For instance, techniques of the present disclosure may enable a user communicating in a real-time communication to granularly control communication with other users. Using techniques of the disclosure, abusive or unwelcomed users may be ignored or expelled from a real-time communication session. In this way, users may communicate in an enjoyable and productive manner in a real-time communication session, which reducing disruptions.

In some examples, techniques of the disclosure may provide for a collaboration environment that more realistically mimics social interactions. For instance, techniques of the disclosure may enable a majority of users to expel an abusive user from a real-time communication session. In other examples, a “host” with special privileges may remove the user from the real-time communication session. In some examples, techniques of the present disclosure enable a user to ignore an annoying or abusive user by disabling communication between the two users. By improving the realistic nature of the social interaction, techniques of the present disclosure provide an effective way to communicate without being in the same physical location.

Techniques of the present disclosure may also enable a first user to choose whether to communicate with a second user who joins a communication session before the identity of the first user is made known to the second user. For instance, by disabling communication between the first and second users when the second user joins the real-time communication session, the first user can decide to exit the real-time communication session in a way that is transparent to other users in the real-time communication session and undetectable by the second user. In this way, awkwardness between users in the real-time communication session may be reduced when the first user exits the session in response to the second user joining the session.

### EXAMPLE DEVICE

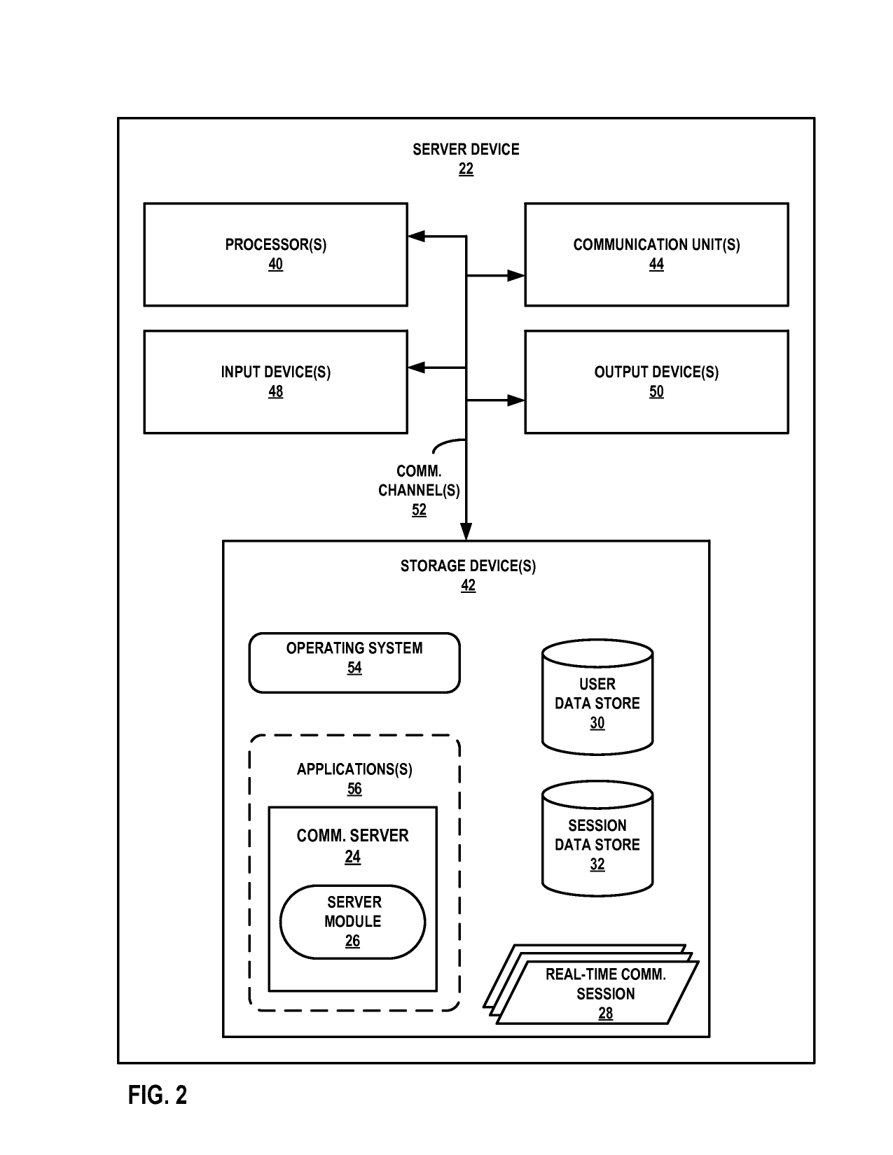

FIG. 2 is a block diagram illustrating further details of one example of a computing device shown in FIG. 1, in accordance with one or more aspects of the present disclosure. FIG. 2 illustrates one particular example of server device 22, and many other example embodiments of server device 22 may be used in other instances.

As shown in the specific example of FIG. 2, server device 22 includes one or more processors 40, storage devices 42, a communication unit 44, one or more input devices 48, and one or more output device 50. Server device 22 also includes an operating system 54 that is executable by server device 22. Server device 22, in one example, further includes communication server 24 that is also executable by server device 22. Each of components 40, 42, 44, 48, 50, 54, 56, 24, 26, 28, 30, and 32 may be interconnected (physically, communicatively, and/or operatively) by communication channels inter-component communications. In some examples, communication channels 52 may include a system bus, network connection, interprocess communication data structure, memory address, or any other channel for communicating data. As one example in FIG. 2, components 40, 44, 48 and 50 may be coupled by one or more communication channels 52. Components 54, 56, 24, 26, 30, 32, and 28 may also be coupled with one another by one or more communication channels and may also be coupled with components 40, 48, 44, and 50.

Processors 40, in one example, are configured to implement functionality and/or process instructions for execution within server device 22. For example, processors 40 may be capable of processing instructions stored in storage devices 42 (e.g., memory and/or other forms of computer-readable storage mediums).. Examples of processors 40 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 42, in one example, are configured to store information within server device 22 during operation. For instance storage device 42 may include a memory. Storage device 42, in some examples, is described as a computer-readable storage medium. In some examples, storage device 42 may be a temporary memory, meaning that a primary purpose of storage device 42 is not long-term storage. Storage device 42, in some examples, is described as a volatile memory, meaning that storage device 42 does not maintain stored contents when the computer is turned off. Examples of volatile memories include random access memories (RAM), dynamic random access memories (DRAM), static random access memories (SRAM), and other forms of volatile memories known in the art. In some examples, storage device 42 is used to store program instructions for execution by processors 40. Storage device 42, in one example, is used by software or applications running on server device 22 (e.g., applications 56) to temporarily store information during program execution.

One or more storage devices 42, in some examples, also include one or more computer-readable storage media. Storage devices 42 may be configured to store larger amounts of information than volatile memory. Storage devices 42 may further be configured for long-term storage of information. In some examples, storage devices 42 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Server device 22, in some examples, also includes a communication unit 44. Server device 22, in one example, utilizes communication unit 44 to communicate with external devices via one or communication channels, such as one or more wired and/or wireless networks. Communication unit 44 may be a network interface card, such as an Ethernet card, an optical transceiver, a radio frequency transceiver, Universal Serial Bus (USB) controller, or any other type of device that can send and receive information. Other examples of such communication units may include 3G and WiFi radios in mobile computing devices. In some examples, server device 22 utilizes communication unit 44 to wirelessly communicate with other computing device, such as computing devices 4A-4C of FIG. 1.

Server device 22, in one example, also includes one or more input devices 48. Input device 48, in some examples, is configured to receive input from a user through tactile, audio, or video feedback. Examples of input device 48 include a presence-sensitive screen, a mouse, a keyboard, a voice responsive system, video camera, microphone or any other type of device for detecting a command from a user.

One or more output devices 50 may also be included in server device 22. Output device 50, in some examples, is configured to provide output to a user using tactile, audio, or video stimuli. Output device 50, in one example, includes a presence-sensitive screen, a sound card, a video graphics adapter card, or any other type of device for converting a signal into an appropriate form understandable to humans or machines. Additional examples of output device 50 include a speaker, a cathode ray tube (CRT) monitor, a liquid crystal display (LCD), organic light emitting diode (OLED) display, or any other type of device that can generate intelligible output to a user.

Server device 22 may include operating system 54. Operating system 54, in some examples, controls the operation of components of server device 22. For example, operating system 54, in one example, facilitates the interaction of one or more applications and/or modules with processors 40, communication unit 44, storage devices 42, input device 48, and output device 50.

As shown in FIG. 2, server device 22 may further include communication server 24, server module 26, real-time communication session 28, user datastore 30, and session datastore 32, as described in FIG. 1. Applications 56, communication server 24, and server module 26 may each include program instructions and/or data that are executable by server device 22. For example, applications 56, communication server 24, server module 26, and operating system 54 may include instructions that cause server device 22 to perform one or more of the operations and actions described in the present disclosure.

In one example, server module 26 may initially generate real-time communication session 28. Server module 26 may generate real-time communication session 28 in response to receiving a request from a client device via communication unit 44. In some examples, server module 26 may associate an identifier that identifies real-time communication session 28 with real-time communication session 28. For instance, an identifier that identifies real-time communication session 28 may be a Uniform Resource Locator (URL).

In some examples, various communication clients may couple to real-time communication session 28 by accessing the identifier. For instance, the identifier that identifies real-time communication session 28 may be included in a web page that is hosted by communication server 24. In such examples, user 2A for example may cause client device 4A to retrieve the web page from communication server 24. User 2A may provide a user input to select the identifier that identifies communication session 28. Communication module 8A may generate a request that is sent to server module 26. Upon receiving the request via communication unit 44, server module 26 may couple communication module 8A to real-time communication session 28. In this way, communication module 8A may couple to real-time communication session 28 by accessing the identifier.

User 2B may subsequently couple to real-time communication session 28 by access the identifier that identifies real-time communications session 28. For instance, user 2B may provide a user input to input device 10B that causes communication module 8B to generate a request to couple to real-time communication session 28. The request may be sent by communication module 8B to server module 26.

The request may initially be received by communication unit 44 and sent to server module 26. Server module 26 may determine whether to enable communication using real-time communication session 28 between users 2A and 2B. In the current example, upon receiving the request, server module 26 may determine that user 2B may communicate with user 2A and therefore couple communication module 8B to real-time communication session 28. In one example, to couple communication module 8B to real-time communication 28, server module 26 may send a message to communication module 8B using communication unit 44 that enables communication module 8B to establish a network connection to real-time communication session 28. In some examples, the message may include authentication credentials or other information usable to establish the network connection to real-time communication session 28. Once communication module 8B is coupled to real-time communication session 28, server module 26 may send audio and/or video feeds to various communication modules 8A and 8B coupled to real-time communication session 28.

At a later time, user 2A may wish to prevent user 2B from communicating with user 2A using real-time communication session 28. For instance, user 2A may provide a user input at input device 10A to select a user interface component included in GUI 16. The user interface component may indicate that, when selected, communication between user 2A and 2B may be disabled. When user 2A selects the user interface component, communication module 8A may generate a request that is sent to server module 26 to disable communication between user 2A and 2B.

Communication unit 44 may initially receive the request, which is sent to server module 26. Server module 26 may, in response to receiving the request, disable communication between communication modules 8A and 8B. In some examples, disabling communication between communication modules 8A and 8B may include server module 26 refraining from sending video and/or audio feeds generated by communication module 8A to communication module 8B. Disabling communication between communication modules 8A and 8B may include server module 26 refraining from sending video and/or audio feeds generated by communication module 8B to communication module 8A.

In another example, user 2C may wish to communicate using real-time communication session 28. In such an example, user 2C may provide a user input at input device 10C that causes communication module 8C to generate a request to couple to real-time communication session 28. In some examples, communication module 8C may send a user identifier that identifies user 2C to server module 26. Communication unit 44 may receive the request, which may be sent to server module 26.

In some examples, server module 26 may determine whether user 2C is indicated in an access control list associated with user 2A. In one example, an access control list may be a blacklist that indicates a group of one or more users that are not allowed to communicate with a user using a real-time communication session. In another example, an access control list may be a whitelist that indicates a group of one or more users that are allowed to communicate a user using a real-time communication session. An access control user may be configurable by a user, stored in user datastore 30, and associated with the user for later retrieval.

In the current example, server module 26 may determine that user 2A is communicating using real-time communication session 28. Server module 26 may select a blacklist associated with user 2A from user datastore 30. In some examples, server module 26 may compare the user identifier that identifies user 2C with the blacklist associated with user 2A. Real-time communication session 28 may determine that user 2C is included in the blacklist. Consequently, in one example, server module 26 may disable communication between user 2A and 2C using real-time communication session 28. In other examples, server module 26 may decouple communication module 2A from server module 26 in response to determine that user 2C is indicated on the black list associated with user 2A.

In some examples, server module 26 implements techniques that may deter some users from accessing real-time communication session 28 from unauthorized remote computing devices, thereby improving user privacy of users communicating using the real-time communication session. For instance, in one example, user 2B may include an identifier (e.g., URL) that identifies real-time communication session 28 in a web page hosted on a remote computing device that is not authorized to share the identifier. In the current example, only server device 22 may be authorized to share the identifier, e.g., include the identifier in a web page that is hosted by communication server 24.

User 2C may, in one example, access real-time communication session 28 using a communications client executing at client device 4C that includes a web browser application and communications module 8C. User 2C may use the web browser application to load the web page that includes the identifier that identifies real-time communication session 28. The web page may be hosted by an unauthorized remote computing device. User 2C may provide a user input at input device 10A to select a hyperlink that corresponds to the identifier that identifies real-time communication session 28. In such examples, the web browser application may send a request to server module 26 that includes the identifier that identifies real-time communication session 28. The request may further include request data such as a Hypertext Transfer Protocol cookie. The web browser may select the request data for inclusion in the request based in part information associated with the unauthorized remote computing device. For instance, the web browser may include request data based on a network domain associated with the unauthorized remote computing device. The request data selected by the web browser may be specific the network domain of the unauthorized remote computing device.

When communication unit 44 receives the request from the web browser executing at client device 4C, communication unit 44 may send the request to server module 26. Sever module 26 may determine whether the request received from client device 4C includes an identifier that identifies real-time communication session 28. When the request includes an identifier that identifies real-time communication session 28, server module 26 may determine whether the identifier was accessed from a remote computing device that is not authorized to share the identifier. For instance, server module 26 may determine whether request data (e.g., HTTP cookie data) included in the request indicates the identifier was accessed from an authorized remote computing device.

In one example, server module 26 may check for the presence of one or more values in the request data that indicate the identifier was accessed from an authorized remote computing device. For instance, if the request was generated by a web browser in response to accessing the identifier from an authorized remote computing device, the web browser may select one or more values based on attributes of the authorized remote computing device (e.g., domain name) that indicate the server is authorized. The selected one or more values may be included in the request data of the request generated by the web browser.

Server module 26, upon receiving the request, may check for the presence of the one or more values in the request data. If the request data includes the one or more values that indicate the server is authorized, server module 26 may send a message to client device 4C that enables communication module 4C to couple to real-time communication session 28. In other examples, if the identifier was accessed from an unauthorized remote computing device, the web browser executing at client device 4C, when generating the request, will not select the one or more values that indicate the remote computing device is authorized. When the request is received by server module 26, server module 26 may determine whether the request data included in the request includes the one or more values that indicate the remote computing device is authorized. In the current example, because the identifier was accessed from an unauthorized remote computing device, the request data included in the request will not include the one or more values that indicate the remote computing device is authorized. Consequently, server module 26 may deny communication module 4C from coupling to real-time communication session 28.

### EXAMPLE OPERATIONS

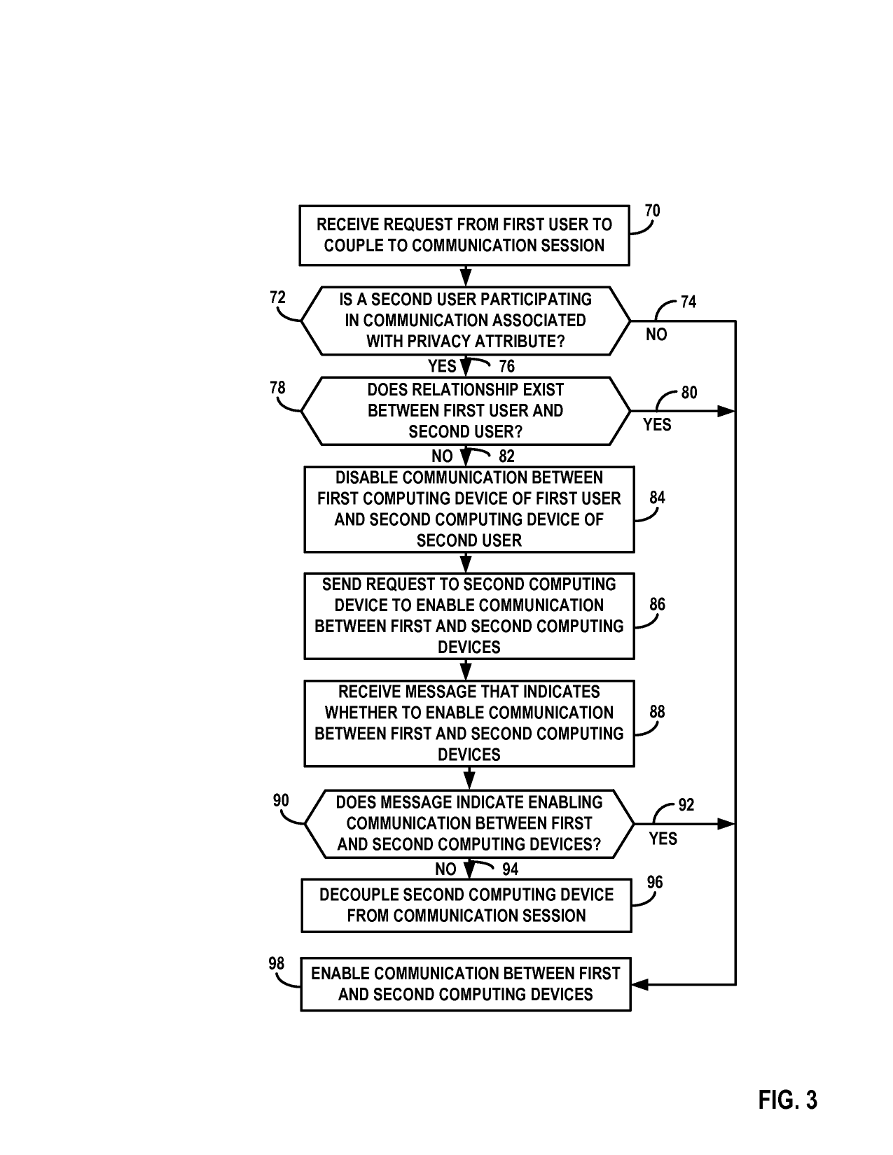

FIG. 3 is a flow diagram illustrating example operations of a computing device that may enable a second user participating in a real-time communication session to choose whether to communicate with a first user that joins the real-time communication session, in accordance with one or more aspects of this disclosure. For purposes of illustration, the example method is described below within the context of remote server device 22 and computing devices 4 as described in FIGS. 1 and 2.

In the example of FIG. 3, communication module 8A of communication client 6A may be initially coupled to real-time communication 28 by server module 26. At a later time, user 2C may wish to communicate using real-time communication 28. Consequently, user 2C may provide a user input at input device 10C that causes communication module 8C to generate a request to couple communication module 8C to real-time communication session 28. Communication module 8C may send the request to server module 26.

Server module 26 may initially receive the request from user 2C to couple to real-time communication session 28 (70). Upon receiving the request, server module 26 may determine if any of the users currently communicating using real-time communication session 28 are associated a with a privacy attribute (72). The privacy attribute may indicate that a user associated with the privacy attribute will be prompted to choose whether to communicate with new users that join a real-time communications session. For instance, a privacy attribute may be associated with users who are identified as minors, for example, user who are under a pre-defined age (e.g., 18 years of age). In other examples, any user may select that the privacy attribute be associated with his/her profile information stored in user datastore 30. If, for example, user 2A is not associated with a privacy attribute (74), server module 26 may enable communication between communication modules 8A and 8C using real-time communication session 28 (98).

If user 2A is associated with a privacy attribute, server module 26 may determine that user 2A is associated with the privacy attribute (78). Consequently, server module 26 may determine whether a relationship exists between user 2A and 2C. For instance, server module 26 may query user datastore 30 determine whether user 2C is included in user 2A's social network. For instance, server module 26 may determine if data in user datastore 30 indicates that a relationship exists between user 2A and user 2C. In some examples, the relationship between user 2A and 2C must have been initiated and/or otherwise authorized by user 2A. For example, the relationship may be an asymmetric relationship initiated or authorized by user 2A that empowers user 2A to decide, using techniques of the present disclosure, whether communication may be disabled in a communication session with other users. Thus, in some examples, the relationship between user 2A and 2C may not be a generic multi-way relationship or a relationship that is generated by user 2C without user 2A's authorization or initiation. For instance, user 2A may initiate a relationship by adding user 2C to a social group that user 2A uses to organize groups of users in a social network. User 2A may also initiate a relationship by inviting user 2C to create a relationship, such as becoming “friends,” in a social network. User 2A may also authorize a relationship if, for example, user 2C invited user 2A to create a relationship in the social network. In contrast, server module 26 may determine that a relationship does not between users 2A and 2C if user 2C adds user 2A to a user 2C's social group but user 2A does not further initiate or authorize the relationship. Returning to FIG. 3, if a relationship exists between user 2A and 2C (80), server module 26 may enable communication between communication modules 8A and 8C using real-time communication session 28 (98).

If a relationship does not exist between user 2A and 2C (82), server module 26 may disable communication between communication modules 8A and 8C (84). In other examples, if a relationship does not exist between user 2A and 2C, server module 26 may disable communication between communication module 8A and all other communication modules currently coupled to real-time communication session 28. Server module 26 may, in some examples, send messages to a group of communication modules coupled to real-time communication session 28 that cause the communication modules to display an indication that communication of user 2A using real-time communication session 28 has been disabled. For instance, in response to communication modules receiving the messages, the video feed associated with user 2A that is displayed by other communication modules coupled to real-time communication session 28 may display an indication that communication of user 2A using real-time communication session 28 has been disabled. In some examples, the group of communication modules may not include communication module 8C.

In an alternative example, server module 26 may disable communication between communication modules 8A and 8C by disallowing communication module 8C executing on client device 4C from initially coupling to the real-time communication session 28. For example, communication module 8C may be required to wait to couple to real-time communication session 28 until server module 26 receives a message from communication module 8A that enables communication module 8C to couple to real-time communication session 28. For instance, when communication module 8C initially attempts to couple to real-time communication session 28, server module 26 may send a message to communication module 8C indicating that the communication module 8C can couple to real-time communication session 28 only after receiving a subsequent message from server module 26 that enables communication module 8C to couple to real-time communication session 28. In one example, the message may cause communication module 8C to display a graphical user interface that indicates and/or represents a virtual waiting room, wherein user 2C can wait until a message is received by communication module 8C that allows or prevents user 2C from communicating with users 2A and/or 2B using real-time communication session 28.

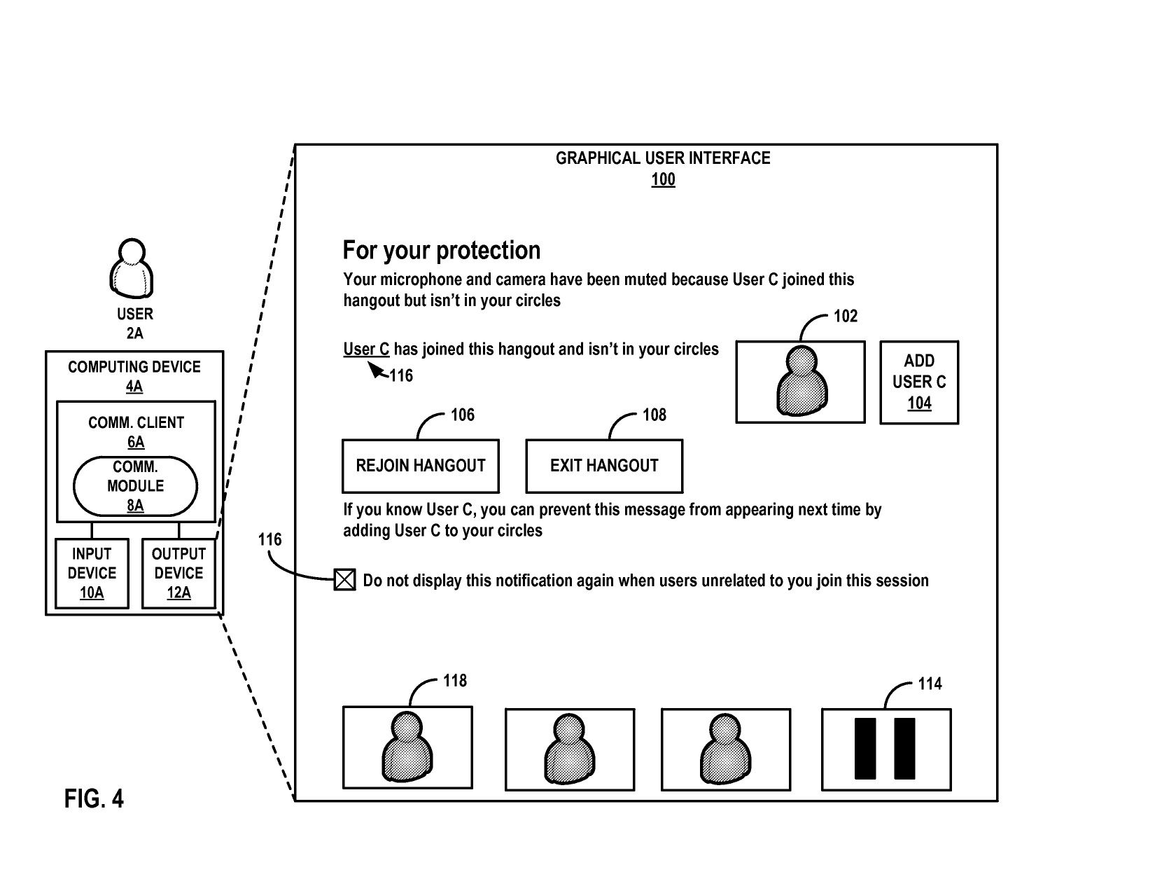

In the current example, server module 26 may send a request to communication module 8A to provide information to user 2A, such that communication module 8A is capable of receiving input from user 2A to enable communication module 8C to couple to the real-time communication session 28. For instance, communication module 8A may display a graphical user interface 100 with functionality as described in FIG. 4. User 2A may provide a user input to indicate whether to enable or disable communication module 8C from communicating with communication module 8A using real-time communication session 28. Communication module 8A may send a message to server module 26 with the indication. Server module 26 may then receive the message from communication module 8A that either enables or disables communication between communication module 8A and communication module 8C using the real-time communication session 28. Server module 26 may then enable or disable communication between communication module 8A and communication module 8C based on the indication in the message. For instance, if the message from communication module 8A includes an indication to enable communication between communication module 8C communication module 8A, server module 26 may send a message to communication module 8C that enables communication module 8C to couple to the real-time communication session. Alternatively, if the message from communication module 8A includes an indication to disable communication between communication module 8C communication module 8A, communication module 8C may receive a message to indicate this and prevent communication module 8C from coupling to real-time communication session 28.

In yet another alternative example, server module 26 may disable communication between communication modules 8A and 8C by enabling communication module 8C to couple to real-time communication session 28 but preventing communication between users 2A and 2C using real-time communication session 28 until user 2A enables communication with user 2C. For example, communication module 2C may initially couple to communication session 28. To disable communication between communication modules 2A and 2C, server module 26 may send one or more messages to communication module 8A that disables communication module 8A from outputting audio and/or video feeds associated communication module 8C. Similarly, server module 26 may send one or more messages to communication module 8C that disables communication module 8C from outputting audio and/or video feeds associated communication module 8A. In this way, communication module 2C may couple to real-time communication session 28 thereby enabling user 2C to participate, while preventing user 2C from communicating with user 2A until user 2A approves of such communication. For example, server module 26, upon determining that communication module 8C has couple to real-time communication session 28, may send a message to communication module 8A. The message, when received by communication module 8A may allow user 2A to select whether to enable communication between communication modules 8A and 8C. Communication module 8A may send a message that indicates user 2A's selection to server module, which subsequently enables or continues to disable communication between communication modules 8A and 8C.

Returning to FIG. 3, in some examples, server module 26 may send a request to communication module 8A that enables user 2A to select whether to enable communication with user 2C using real-time communication session 28 (86). For instance, subsequent to disabling the real-time communication between communication modules 8A and 8C, server module 26 may send a request to communication module 8A to provide information to user 2A, such that communication module 8A is capable of receiving input from user 2A to enable real-time communication between communication modules 8A and 8B. In one example, the request, when received by communication module 8A, may cause communication module 8A to generate GUI 100 as shown in FIG. 4 with information usable by user 2A to enable real-time communication between communication modules 8A and 8B. Server module 26 may, in some examples, select profile information associated with user 2C from user datastore 30 and send the profile information to communication module 8A for display at client device 4A. In this way, user 2A may evaluate the profile information associated with user 2C.

In one example, communication module 8A, upon receiving the request from server module 26, may cause output device 12A to include one or more user interface components. The one or more user interface components may enable user 2A to select whether to enable communication between user 2A and 2C using real-time communication session 28. In one example, user 2A may provide a user input to select a user interface component that cause communication module 8A to generate a message that indicates to server module 26 to enable communication between user 2A and 2C using real-time communication session 28. Upon selecting the user interface component, communication module 8A may send the message to server module 26.

Server module 26 may receive the message from communication module 8A that indicates whether to enable communication between user 2A and 2C using real-time communication session 28 (88). Server module 26 may determine whether the messages indicates that server module 26 may enable communication between user 2A and 2C using real-time communication session 28 (90). In the current example, the message indicates that server module 26 may enable communication between user 2A and 2C using real-time communication session 28 (92). Consequently, server module 26 may enable communication between users 2A and 2C using real-time communication session 28 (98). In some examples, enabling communication between users 2A and 2C using real-time communication session 28 may include server module 26 sending video and/or audio feeds generated by communication module 8C to communication module 8C. Enabling communication between users 2A and 2C using real-time communication session 28 may include server module 26 sending video and/or audio feeds generated by communication module 8C to communication module 8A.

In some examples, the message received by server module 26 from communication module 8A may indicate that server module 26 may not enable communication between user 2A and 2C using real-time communication session 28 (94). In such examples, server module 26 may decouple real-time communication module 8A from real-time communication session 28 (96). Thus, in some examples, when user 2A does not wish to communicate with user 2C, user 2A may cause communication module 8A to generate a message that further causes server module 26 to decouple from real-time communication session 28.

Techniques of the present disclosure may also prevent a user from impersonating another identity when using a real-time communication session based on one or more attributes, such as age, parental control, etc. To illustrate, a user in a social networking service may initially create a user account associated with the user. The user may also create a separate entity account that represents an entity, such as a business, organization, etc. In some examples, the social networking service may associate the user account with the entity account to enable the user administer the entity account. When the user wishes perform an administrative action for the entity account, the user may authenticate using the separate entity account. Administrative actions may include updating content associated with the entity account such as web pages, multimedia content, etc. In this way, the user may impersonate the identity of the separate entity account, such that administrative actions taken by the user are performed using the entity account.

As previously indicated, server module 26 may maintain associations between user accounts and entity accounts created by users (e.g., associations may be stored in user datastore 30). In accordance with techniques of the disclosure, server module 26 may prevent a user from impersonating an entity account when using a real-time communication session based on one or more attributes. For instance, user 2A, as shown in FIG. 1, may be a minor, e.g., under the age of 18 years old. An attribute may therefore be associated with user 2A's account in user datastore 30 to indicate user 2A is a minor. Furthermore, user 2A may be associated with the entity account created by user 2A.

In one example, user 2A may authenticate as the entity account thereby impersonating an identity other than user 2A's user account. Upon authenticating as the entity, user 2A may send a request using communication module 8A to server module 26 to couple to real-time communication session 28. Server module 26 may initially determine whether user 2A is associated with multiple accounts in the social network service. For instance, server module 26 may determine that user 2A is using the entity account that is associated with user 2A's user account. Server module 26 may therefore determine that user 2A is associated with multiple user identifiers, i.e., a first user identifier for user 2A's user account and a second user identifier for the entity account. If user 2A has used multiple entity and/or user accounts to perform the impersonation, server module 26 may traverse the sequence of associations between accounts to identify the originating user account in the sequence of impersonated accounts.

When server module 26 determines that user 2A is using multiple accounts, server module 26 may determine whether one or more user identifiers of user 2A are associated with one or more attributes that prevent user impersonation. In the current example, user 2A's user account is associated with an attribute that indicates an age of user 2A. Server module 26, may determine that when the attribute indicates that the age of user 2A is less than a predefined age, server module 26 enables communication module 8A to couple to real-time communication session 28 only using the user identifier associated with user 2A's user account. In this way, user 2A may only communicate in real-time communication session 28 using user's 2A's user account that indicates user 2A is a minor and not as the entity account. Consequently, techniques of the present disclosure may prevent user impersonation based on one or more attributes when a user is associated with multiple user accounts by requiring the user to participate in communication sessions using the user's actual identity and not an identity of an entity account created by user 2A. While age was described as one example, any suitable attribute such as parental controls or other rules may be associated with a user account to prevent impersonation in real-time communication sessions.

Techniques of the present disclosure may enable a user associated with a privacy attribute to determine whether to continue using a real-time communication session when another user has added application functionality to the real-time communication session. For example, real-time communication session 28 may be configured as a shared application space that enables users participating in real-time communication session 28 to add application functionality to the real-time communication session. In some examples, application functionality may include operations and/or graphical content associated with a video game, multimedia player, calendar, office suite application, etc. One example of adding application functionality to a real-time communication session may include a user sharing video using a video player in the real-time communication session.

In accordance with techniques of the present disclosure, server module 26 may enable user 2A associated with a privacy attribute to determine whether to continue using real-time communication session 28 when user 2B has added application functionality to the real-time communication session. For instance, communication modules 2A and 2B may each be initially coupled to real-time communication session 28. User 2B may wish to share video content with user 2A using real-time communication 28. Consequently, user 2B may send a request to server module 26 to associate application functionality of a video player with the real-time communication session 28. The request may, for example, include video content or an identifier of the video content. Upon receiving the request, server module 26 may determine whether user 2A is associated with a privacy attribute (e.g., an attribute that indicates user 2A is a minor). If user 2A is not associated with a privacy attribute, server module 26 may send one or more indications of the application functionality associated with the video player to communication module 8A. The indication of application functionality may include the video content, an identifier of the video content (e.g., a Uniform Resource Locator), an identifier of video player usable by communication module 8A to play the video content, a video player application, and/or any other information usable to display the video content at client device 4A.

In the current example, user 2A may be associated with a privacy attribute. Consequently, when server module 2A determines that user 2A is associated with the privacy attribute, server module 26 may refrain from sending one or more indications of the application functionality associated with the video player to communication module 8A. In this way, user 2A may not be immediately exposed to the application functionality associated with the video player. Communication module 8A may, instead, receive a request that is sent by server module 26, which enables user 2A to determine whether to enable the application functionality associated with the video player using communication module 8A. In one example, communication module 8A may display a graphical user interface similar to graphical user interface 100 of FIG. 4 that enables user 2A to determine whether to exit the real-time communication session. In some examples, the graphical user interface may enable user 2A to determine whether to enable the application functionality associated with the video player using communication module 8A while remaining coupled to real-time communication session 28. User 2A may provide a user input to, for example, enable the application functionality using communication module 8A, which may also cause communication module 8A to send a message to server module 26 to send one or more indications of the application functionality for the video content. Consequently, communication module 8A may begin outputting the video content initially indicated by user 2B based on indications received from server module 26.

In some examples, server module 26 may perform techniques to reduce notifications to user 2A. For instance, as shown in FIG. 3, user 2A may decide to enable communication with user 2C using real-time communication session 28. If user 2C leaves real-time communication session 28 but later returns, user 2A may not wish to be re-notified by server module 26 and decide again whether to enable communication between user 2A and user 2C using real-time communication session 28.

To reduce notifications to user 2A, server module 26 may initially store data that indicates user 2A has elected to enable communication with user 2C using real-time communication session 28. Server module 26 may subsequently determine that communication module 8C has decoupled from real-time communication session 28 (e.g., user 2C is no longer communicating using real-time communication session 28). At a later time, user 2C may wish to re-join real-time communication session 28. Consequently, user 2C may provide a user input to re-join, which causes communication module 8C to send a request to server module 26 to couple to real-time communication session 28.

Upon receiving the request, server module 26 may determine, using the previously stored data, whether user 2A has previously decided to enable real-time communication between the communication modules 8A and 8C. In the current example, because user has previously enabled real-time communication with user 2C, server module 26 may refrain from disabling real-time communication between the communication modules 8A and 8C. In some examples, server module 26 also refrains from sending a message to communication module 8A to request whether user 2A wishes to enable communication between communication modules 8A and 8C. Instead, server module 26 may enable communication module 8C to re-couple to real-time communication session 28 without sending a notification to communication module 8A. In this way, user 2A may not be required to re-submit a decision to communicate with user 2C and user 2C may be able to immediately couple to real-time communication session 28.In some examples, server module 26 may configure real-time communication session 28 such that when user 2A attempts to join the communication session, server module 26 may notify user 2A that real-time communication will not be disabled between communication module 8C and client devices coupled to real-time communication session 28 that are associated with users not having a relationship to user 2A. For instance, server module 26 may initially receive a request from communication module 8A to couple to real-time communication session 28. Upon receiving the request, server module 26 may send a message to communication module 8A that that indicates real-time communication will not be disabled between communication module 8A and other client devices coupled to real-time communication session 28 that are associated with users not having a relationship to user 2A. The message may further include information that describes the real-time communication session such as the topic, content, participants or other corresponding information.

Communication module 8A, upon receiving the request, may enable user 2A to decide whether to join real-time communication session 28. Upon receiving a selection from user 2A, communication module 8A may send a request to server module 26 to couple to real-time communications session 28. Server module 26 may then enable communication module 8A to couple to real-time communication session 28, and, in some examples, send a message to communication module 8A that enables the module to couple to the session. When subsequent users that do not have a relationship with user 2A join real-time communication session 28, server module may refrain from disabling real-time communication between communication module 8A and communication modules of client devices associated with the users not having relationships with user 2A. In this way, techniques of the disclosure allow user 2A to decide whether to participate in a real-time communication session that may be configured to refrain from notifying user 2A when another user not having a relationship to user 2A joins the session.

### EXAMPLE USER INTERFACE

FIG. 4 is a diagram illustrating one example of a graphical user interface of a communication client, in accordance with one or more aspects of the present disclosure. As shown in FIG. 4, computing device 4A may include communication client 4A, communication module 8, input device 10A, and output device 12A as described in FIG. 1. Communication module 8A may cause output device 12A to display GUI 100 in response to receiving a request from server module 26. The request from server module 26 may be generated in response to user 2C (as shown in FIG. 1) joining real-time communication session 28. For instance, server module 26 may couple communication module 8C to real-time communication session 28. In response, server module 26 may disable communication between user 2A and 2C using real-time communication session 28. Server module 26 may further send the request to communication module 8A that causes output device 12A to display GUI 100. Server module 26 may also send profile information associated with user 2C to communication module 8A.

As shown in FIG. 4, communication module 8A, in response to receiving the request, may include profile information associated with user 2C in GUI 100. As shown in FIG. 4, profile information may include an image associated with user 2C. GUI 100 may also include other profile information in GUI 100 or include a link 116 to the profile information associated with user 2C that when selected retrieves the profile information for display in GUI 100.

In some examples, communication module 8A may cause GUI 100 to include a user interface component 104 to create a relationship between user 2A and 2C. For instance, when user 2A provides a user input to select user interface component 104, communication module 8A may generate a message that includes an indication to create a relationship between user 2A and 2C. In one example, communication module 8A may send the message to server module 26. Server module 26, upon receiving the message, may generate the relationship between user 2A and 2C. For example, upon receiving the message, server module 26 may store an association in user datastore 30 that indicates user 2C is included in user 2A's social network.

In some examples, communication module 8A may cause GUI 100 to include user interface components 106 and 108. When user 2A provides a user input at input device 10A to select user interface component 106, communication module 8A may generate a message that causes server module 26 to enable communication between user 2A and 2C using real-time communication session 28. Communication module 8A may send the message to server module 26. When user 2A alternatively provides a user input to select user interface component 108, communication module 8A may generate a message that causes server module 26 to decouple communication module 8A from real-time communication session 28. Communication module 8A may send the message to server module 26 as previously described.

In some examples, GUI 100 may include video feeds generated by communication modules associated with real-time communication session 28. Video feed 118 may include a visual representation of user 2B's participation in real-time communication session 28. Video feed 114 may be generated by communication module 8A and include a visual representation of user 2A's participation in real-time communication session 28. In some examples, GUI 100 may not include a video feed of user 2C. Similarly, in some examples, the GUI displayed by output device 12C of client device 4C may not include a video feed of user 2A.

In other examples, a video feed of user 2A may be included in the GUI of client device 4C but the content of the video feed may be blocked by an image, such as a completely black image. In other examples, the video feed of user 2A may be disabled and a placeholder may be indicated in the GUI of client device 4C. When a video feed blocked by an image or a video feed placeholder is included in the GUI of client device 4C, the audio feed associated with user 2A may also be disabled by communication module 8C until a message is received by communication module 8C to enable real-time communication using real-time communication session 28.

GUI 100 may also include a user interface component 116 that, when selected, indicates to server module 26 not to disable real-time communication between user 2A and subsequent users that join real-time communication session 28. For example, user 2A may provide a user input to select user interface component 116 (e.g., a checkbox control). Communication module 8A, in response determining the user input, may send a message to server module 26 that indicates to server module 26 not to disable real-time communication between the communication module 8A and another communication module that subsequently couples to real-time communication session 26 event though a relationship does not exist between user 2A and the user associated the subsequently coupled communication module. In some examples, server module 26 may therefore allow subsequent users that do not have a relationship to user 2A to join real-time communication 28 without disabling real-time communication with communication module 8A. In this way, the previously described example techniques may enable user 2A to prevent further notifications and/or disabling of communications when users join real-communication session that do not have a relationship with user 2A.

In one example, when user 2C joins real-time communication session 28, a request is sent by server module 26 to communication module 8A to enable communication between user 2A and 2C using real-time communication session 28 as previously described. Communication module 8A, upon receiving the request, may cause video feed 114 to indicate that communication between user 2A and 2C using real-time communication session 28 has been disabled. As shown in FIG. 4, the indication may be a “pause” indicator to indicate that communication between user 2A and 2C using real-time communication session 28 has been disabled, e.g., paused.

In some examples, when user 2C joins real-time communication session 28, a message is sent by server module 26 to communication module 8B that indicates communication between users 2A and 2C using real-time communication session 28 has been disabled. Communication module 8B may include similar video feeds as shown in GUI 100 that are each associated with users communicating using real-time communication session 28. In response to receiving the message, communication module 8B may display an indication at the video feed associated with user 2A that indicates communication between users 2A and 2C using real-time communication session 28 has been disabled. In some examples, the indication may further include a user interface component such as a hyperlink that when selected causes communication module 8B to access a privacy policy or other notification that provides and explanation why communication between users 2A and 2C using real-time communication session 28 has been disabled.

As described in FIG. 1, multiple users may simultaneously or in short period of time, (e.g., 0-30 seconds) attempt to join real-time communication session 28. In such examples, communication modules executing on client devices of each user attempting to join real-time communication session 28 may generate requests that are sent to server module 26. Server module 26 may receive the requests and queue the requests in the order in which the requests are received by server module 26.

In one example, server module 26 may determine that a privacy attribute is associated with user 2A. Server module 26 may subsequently send indications that indicate the requests to communication module 8A. In some examples, the indications may be sent by server module 26 to communication module 8A in the order in which the requests have been queued by server module 26. When the indications of the requests are received at communication module 8A, communication module 8A may cause output device 12A to configure GUI 100 for each indication in sequential order as the indications are received. Thus, user 2A may make a decision whether to re-join real-communication session 28 using GUI 100 for each indication received by communication module 8A. Once user 2A has provided a user input with respect to re-joining real-time communication session 28 for a first user indicated in GUI 100, communication module 8A may configure GUI 100 to display relationship and/or profile information associated with the user of the next queued indication that indicates a request.

### EXAMPLE OPERATIONS

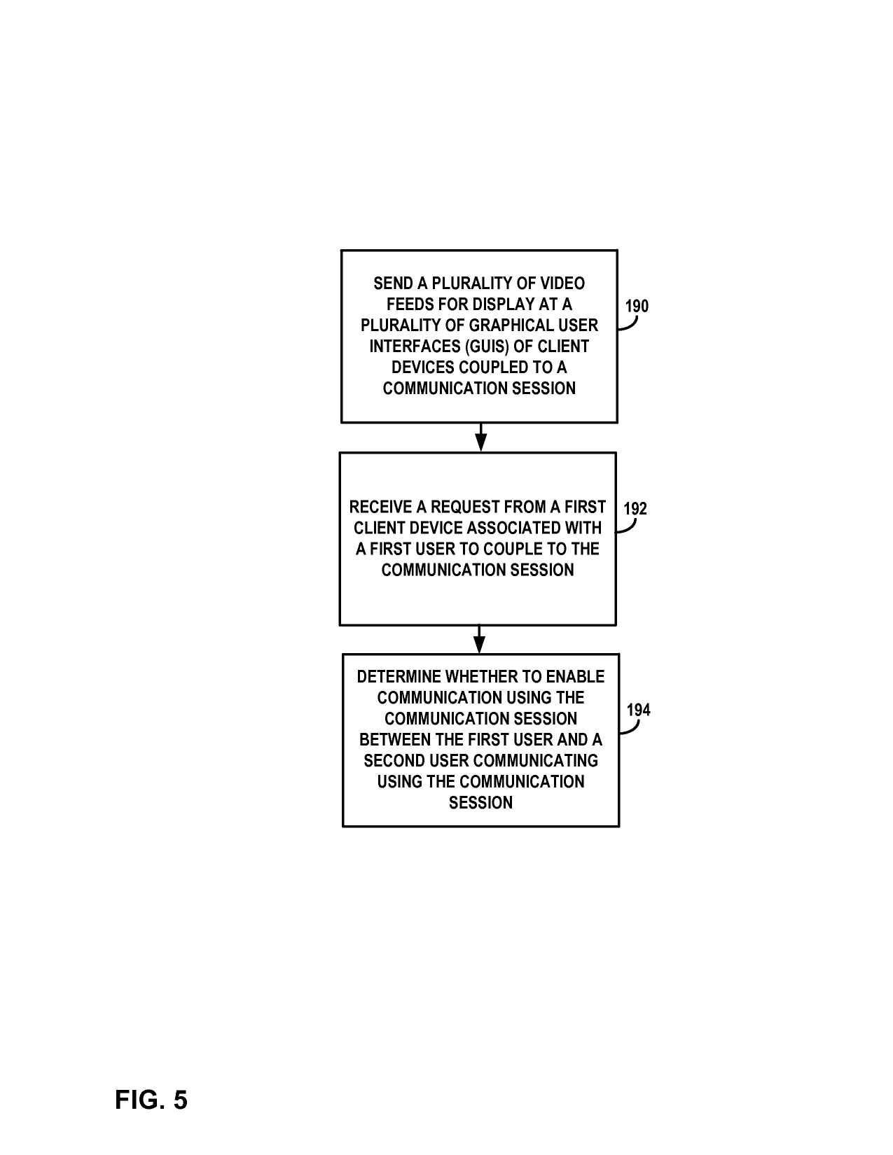

FIG. 5 is a flow diagram illustrating example operations of a computing device that may enable a second user participating in a real-time communication session to choose whether to communicate with a first user that joins the real-time communication session, in accordance with one or more aspects of this disclosure. For purposes of illustration, the example method is described below within the context of server device 22 as described in FIGS. 1 and 2. The operation s of FIG. 5 may include sending, by a computing device, a plurality of video feeds for display at a plurality of graphical user interfaces (GUIs) of client devices coupled to a real-time communication session (190). The real-time communication session enables communication among a plurality of users associated with the client devices, and wherein at least one of the plurality of video feeds comprises a visual representation of user participation in the real-time communication session. The operations may include receiving, by the computing device, a request from a first client device to couple to the real-time communication session, wherein a first user is associated with the first client device (192). The operations may also include, in response to receiving the request, determining, by the computing device, whether to enable communication using the real-time communication session between the first user and a second user associated with a second client device coupled to the real-time communication session.

In some examples, the operations may include determining, by the computing device, whether a relationship exists between the first user and the second user; and when the relationship does not exist between the first user and the second user, disabling communication between the first client device and the second client device. In some examples, the operations may include in response to disabling communication between the first client device and the second client device, sending, by the computing device, a request to the second client device that enables the second user to select whether to enable communication between the first client device and the second client using the real-time communication session.

In some examples, the operations may include receiving, by the computing device, a message from the second client device that indicates whether to enable communication between the first client device and the second client using the real-time communication session; when the message comprises an indication to enable communication between the first and second client devices, enabling, by the computing device, communication between the first client device and the second client device using the real-time communication session; and when the message does not comprise an indication to enable communication between the first and second client devices, decoupling, by the computing device, the second client device from the real-time communication session. In some examples, the operations may include selecting, by the computing device, profile information associated with the first user, wherein the profile information comprises one or more attributes associated with the first user; and sending, by the computing device, the profile information for display at the second client device.

In some examples, the operations may include determining, by the computing device, whether the message comprises an indication to create a relationship between the first user and the second user; and when the message comprises the indication to create the relationship, generating, by the computing device, the relationship between the first user and the second user. In some examples, the operations may include refraining from sending, by the computing device, a first video feed associated with the first client device to the second client device; and refraining from sending, by the computing device, a second video feed associated with the second client device to the first client device.

In some examples, the operations may include sending to a group of the client devices coupled to the real-time communication session, by the computing device, an indication that indicates communication has been disabled between the first client device and the second client device, wherein the group of the client devices does not include the first client device. In some examples, the operations may include determining, by the computing device, whether the second user is included in a social network associated with the first user. In some examples, the operations may include selecting, by the computing device, profile information associated with the first user, wherein the profile information comprises one or more attributes associated with the first user; and sending, by the computing device, the profile information to at least one of the client devices coupled to the real-time communication session.

In some examples, the operations may include determining, by the computing device, whether a relationship exists between the first user and at least one user associated with at least one of the client devices coupled to the real-time communication session; and when the relationship exists between the first user and the at least one user, sending, by the computing device, an indication of the relationship to at least one of the client devices coupled to the real-time communication session. In some examples, the operations may include receiving, by the computing device, a group of indications from the client devices coupled to the real-time communication session, wherein the indications indicate whether the first user is allowed to communicate using the real-time communication session; and when a quantity of indicators of the group of indicators that indicate the first user is not allowed to communicate using the real-time communications session is greater than a defined value, disallowing, by the computing device, the first computing device from coupling to the real-time communication session.

In some examples, the operations may include receiving, by the computing device, an indication from the second client device, wherein the indication indicates whether the first user is allowed to communicate using the real-time communication session; determining, by the computing device, whether the second user is associated with an attribute that enables the second user to deny the first computing device from coupling to the real-time communication session; when the second user is associated with the attribute, determining, by the computing device, whether the indication indicates that the first user is not allowed to couple to the real-time communication session; and when the indication indicates that the first user is not allowed to couple to the real-time communication session, disallowing, by the computing device, the first computing device from coupling to the real-time communication session.

In some examples, the operations may include receiving, by the computing device, a second request from a third client device after receiving the request from the first client device; queuing, by the computing device, the second request and the request from the first client device in a queue, wherein the second request and the request from the first client device are queued in an order in which the second request and the request from the first client device are received by the computing device; and sending, by the computing device to a group of the client devices coupled to the real-time communication session, indications that indicate the second request and the request from the first client, wherein the indications are sent in the order in which the second request and the request from the first client device are received by the computing device.

In some examples, the operations may include determining, by the computing device, whether the first user is indicated in an access control list, wherein the access control list indicates a group of users that are not allowed to communicate with the first user using the real-time communication session; and when the first user is indicated in the access control list, disabling communication between the first client device and the second client device. In some examples, the operations may include receiving, by the computing device, a request from at least one of the client devices coupled to decouple the first client device from the real-time communication session; and in response to receiving the request, decoupling, by the computing device the first client device from the real-time communication session.

In some examples, the operations may include receiving, by the computing device, a request from at least one of the client devices coupled to the real-time communication session to disable communication between the first client device and the second client device; and in response to receiving the request, disabling communication between the first client device and the second client device. In some examples, the operations may include associating, by the computing device, an identifier with the real-time communication session, wherein the identifier identifies real-time communication session.

In some examples, the operations may include determining, by the computing device, whether the request received from the first client device comprises the identifier that identifies the real-time communication session; when the request comprises the identifier, determining, by the computing device and based in part on the request, whether the identifier was accessed by the first client device from a remote computing device that is not authorized to share the identifier; when the identifier was accessed from the remote computing device that is not authorized to share the identifier, disallowing, by the computing device, the first computing device from coupling to the real-time communication session. In some examples, the identifier may include a Uniform Resource Locator.

It will be understood that components included in the figures of this disclosure are illustrated in various configurations and arrangements for example purposes. Such components may be distributed among one or more computing devices in different example configurations and arrangements to perform the techniques as described herein. As such, the example configurations and arrangements of the components as shown in the various figures should not be interpreted as the only such possible configurations and arrangements to perform the techniques of the disclosure.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache). Various embodiments have been described. These and other embodiments are within the scope of the following claims.

What is claimed is:

1. A method comprising:
receiving, by one or more computing devices, a request from a first client device to couple to a real-time communication session, wherein the first client device is associated with device first user, and wherein the real-time communication session enables real-time communication among a plurality of users associated with client devices coupled to the real-time communication session;
determining, by the one or more computing devices, whether a second user associated with a second client device that is coupled to the real-time communication session is associated with a privacy attribute;
when the second user is associated with the privacy attribute, determining, by the one or more computing devices, whether a relationship exists between the first user and the second user;
when the relationship does not exist between the first user and the second user, disabling real-time communication between the first client device and the second client device; and
subsequent to disabling the real-time communication, sending, by the one or more computing devices, a request to the second client device to provide information to the second user, such that the second client device is capable of receiving input from the second user to enable real-time communication between the first client device and the second client device.

2. The method of claim 1, wherein disabling real-time communication between the first client device and the second client device further comprises:
enabling, by the one or more computing devices, the first client device to be coupled to the real-time communication session;
sending a first group of one or more messages to the first client device, by the one or more computing devices, that disables output at the first client device of audio and video feeds associated with the second client device; and
sending a second group of one or more messages to the second client device, by the one or more computing devices, that disables output at the first client device of audio and video feeds associated with the first client device.

3. The method of claim 1, wherein disabling real-time communication between the first client device and the second client device further comprises:
disallowing, by the one or more computing devices, the first client device from coupling to the real-time communication session;
receiving, by the one or more computing devices, a message from the second client device to enable communication between the first client device and the second client using the real-time communication session;
in response to receiving the message, enabling, by the one or more computing devices, the first client device to be coupled to the real-time communication session.

4. The method of claim 3, wherein the message is a first message, the method further comprising:
sending, by the one or more computing devices, a second message to the first client device indicating that the first client device can couple to the real-time communication session only after receiving a third message from the one or more computing devices, wherein the third message enables the first client to couple to the real-time communication session; and
in response to receiving, by the one or more computing devices, the first message from the second client device to enable communication between the first client device and the second client, sending, by the one or more computing devices, the third message to the first client device to enable the first client to couple to the real-time communication session.

5. The method of claim 1, further comprising:
receiving, by one or more computing devices, a request from the second client device to couple to the real-time communication session;
determining, by the one or more computing devices, whether the second user associated with the second client device is associated with a plurality of user identifiers;
when the user is associated with the plurality of user identifiers, determining, by the one or more computing devices, whether a user identifier of the plurality of user identifiers is associated with an attribute that indicates an age of the second user; and
when the attribute indicates that the age of the second user is less than a predefined age, enabling, by the computing device, the second client device to couple to the real-time communication session only using the user identifier associated with the attribute that indicates the age of the second user.

6. The method of claim 1, further comprising:
receiving, by the one or more computing devices, a request from the first client device to associate application functionality with the real-time communication session;
when the second user is associated with a privacy attribute, refraining, by the one or more computing devices, from sending one or more indications of the application functionality to the second client device; and
sending, by the one or more computing devices, a request to the second client device that enables the second user to determine whether to enable the application functionality associated with the real-time communication.

7. The method of claim 1, further comprising:
receiving, by the one or more computing devices, a message from the first client device that indicates to the one or more computing devices not to disable real-time communication between the first client device and a third client device when a relationship does not exist between the first user and a third user associated with the third client device.

8. The method of claim 1, wherein the request is a first request, the method further comprising:
determining, by the one or more computing devices, that the first client device has decoupled from the real-time communication session;
receiving, by the one or more computing devices, a second request from the first client device to couple to the real-time communication session;
when the second user has previously enabled real-time communication between the first client device and the second client device, refraining from disabling, by the one or more computing devices, real-time communication between the first client device and the second client device; and
enabling, by the one or more computing devices, the first client device to couple to the real-time communication session.

9. The method of claim 1, further comprising:
when the relationship exists between the first user and the second user, determining, by the computing device, whether the relationship has been at least initiated or authorized by the second user; and
when the relationship has not been initiated or authorized by the second user, disabling, by the one or more computing devices, real-time communication between the first client device and the second client device.

10. The method of claim 1, further comprising:
receiving, by one or more computing devices, a first request from the second client device to couple to the real-time communication session;
sending, by the one or more computing devices, a message to the second client device that indicates real-time communication will not be disabled between the second client device and client devices coupled to the real-time communication session that are associated with users not having a relationship to the second user;
receiving, by the one or more computing devices, a second request from the second client device to couple to the real-time communication session; and
enabling, by the one or more computing devices, the second client device to couple the real-time communication session.

11. The method of claim 1, further comprising:
receiving, by the one or more computing devices, a message from the second client device that indicates whether to enable communication between the first client device and the second client using the real-time communication session;
when the message comprises an indication to enable communication between the first and second client devices, enabling, by the one or more computing devices, communication between the first client device and the second client device using the real-time communication session; and
when the message does not comprise an indication to enable communication between the first and second client devices, decoupling, by the one or more computing devices, the second client device from the real-time communication session.

12. The method of claim 11, further comprising:
determining, by the one or more computing devices, whether the message comprises an indication to create a relationship between the first user and the second user; and
when the message comprises the indication to create the relationship, generating, by the one or more computing devices, the relationship between the first user and the second user.

13. The method of claim 1, further comprising:
selecting, by the one or more computing devices, profile information associated with the first user, wherein the profile information comprises one or more attributes associated with the first user; and
sending, by the one or more computing devices, the profile information for display at the second client device.

14. The method of claim 1, wherein determining whether the relationship exists between the first user and the second user further comprises:
determining, by the one or more computing devices, whether the first user is included in a social network associated with the second user.

15. The method of claim 1, further comprising:
receiving, by the one or more computing devices, a second request from a third client device after receiving the request from the first client device;
queuing, by the one or more computing devices, the second request and the request from the first client device in a queue, wherein the second request and the request from the first client device are queued in an order in which the second request and the request from the first client device are received by the one or more computing devices; and
sending, by the one or more computing devices to a group of the client devices coupled to the real-time communication session, indications that indicate the second request and the request from the first client, wherein the indications are sent in the order in which the second request and the request from the first client device are received by the one or more computing devices.

16. A system, comprising:
one or more processors;
a server module executable by the one or more processors to:
receive a request from a first client device to couple to a real-time communication session, wherein the first client device is associated with device first user, and wherein the real-time communication session enables real-time communication among a plurality of users associated with client devices coupled to the real-time communication session;
determine whether a second user associated with a second client device that is coupled to the real-time communication session is associated with a privacy attribute;
determine, when the second user is associated with the privacy attribute, whether a relationship exists between the first user and the second user;
disable real-time communication between the first client device and the second client device when the relationship does not exist between the first user and the second user; and
send, subsequent to disabling the real-time communication, a request to the second client device to provide information to the second user, such that the second client device is capable of receiving input from the second user to enable real-time communication between the first client device and the second client device.

17. The system of claim 16, wherein the server module is executable by the one or more processors to:
receive a message from the second client device that indicates whether to enable communication between the first client device and the second client using the real-time communication session;
enable communication between the first client device and the second client device using the real-time communication session when the message comprises an indication to enable communication between the first and second client devices; and
decouple the second client device from the real-time communication session when the message does not comprise an indication to enable communication between the first and second client devices.

18. The system of claim 16, wherein the server module, to disable real-time communication between the first client device and the second client device, is further executable by the one or more processors to:
send a first group of one or more messages to the first client device that disables output at the first client device of audio and video feeds associated with the second client device; and
send a second group of one or more messages to the second client device that disables output at the first client device of audio and video feeds associated with the first client device.

19. A method comprising:
sending, by one or more computing devices, a plurality of video feeds for display at a plurality of graphical user interfaces (GUIs) of client devices coupled to a real-time communication session, wherein the real-time communication session enables communication among a plurality of users associated with the client devices, and wherein at least one of the plurality of video feeds comprises a visual representation of user participation in the real-time communication session;
receiving, by one or more computing devices, a request from a first client device to couple to the real-time communication session, wherein a first user is associated with the first client device; and
in response to receiving the request, determining, by the one or more computing devices, whether to enable communication using the real-time communication session between the first user and a second user associated with a second client device coupled to the real-time communication session.

20. The method of claim 19, wherein determining whether to enable communication using the real-time communication session between the first user and the second user comprises:
selecting, by the one or more computing devices, profile information associated with the first user, wherein the profile information comprises one or more attributes associated with the first user; and
sending, by the one or more computing devices, the profile information to at least one of the client devices coupled to the real-time communication session.

21. The method of claim 19, wherein determining whether to enable communication using the real-time communication session between the first user and the second user comprises:
determining, by the one or more computing devices, whether a relationship exists between the first user and at least one user associated with at least one of the client devices coupled to the real-time communication session; and
when the relationship exists between the first user and the at least one user, sending, by the one or more computing devices, an indication of the relationship to at least one of the client devices coupled to the real-time communication session.

22. The method of claim 19, wherein determining whether to enable communication using the real-time communication session between the first user and the second user comprises:
receiving, by the one or more computing devices, a group of indications from the client devices coupled to the real-time communication session, wherein the indications indicate whether the first user is allowed to communicate using the real-time communication session; and
when a quantity of indicators of the group of indicators that indicate the first user is not allowed to communicate using the real-time communications session is greater than a defined value, disallowing, by the one or more computing devices, the first client device from coupling to the real-time communication session.

23. The method of claim 19, wherein determining whether to enable communication using the real-time communication session between the first user and the second user comprises:
receiving, by the one or more computing devices, an indication from the second client device, wherein the indication indicates whether the first user is allowed to communicate using the real-time communication session;
determining, by the one or more computing devices, whether the second user is associated with an attribute that enables the second user to deny the first client device from coupling to the real-time communication session;
when the second user is associated with the attribute, determining, by the one or more computing devices, whether the indication indicates that the first user is not allowed to couple to the real-time communication session; and
when the indication indicates that the first user is not allowed to couple to the real-time communication session, disallowing, by the one or more computing devices, the first client device from coupling to the real-time communication session.

24. The method of claim 19, further comprising:
selecting, by the one or more computing devices, profile information associated with the first user, wherein the profile information comprises one or more attributes associated with the first user; and
sending, by the one or more computing devices, the profile information for display at the second client device.

25. The method of claim 19, wherein determining whether the relationship exists between the first user and the second user, further comprises:
determining, by the one or more computing devices, whether the first user is included in a social network associated with the second user.

26. The method of claim 19, further comprising:
receiving, by the one or more computing devices, a request from at least one of the client devices coupled to the real-time communications session to decouple the first client device from the real-time communication session; and
in response to receiving the request, decoupling, by the one or more computing devices, the first client device from the real-time communication session.

27. The method of claim 19, further comprising:
receiving, by the one or more computing devices, a request from at least one of the client devices coupled to the real-time communication session to disable communication between the first client device and the second client device; and
in response to receiving the request, disabling communication between the first client device and the second client device.

28. The method of claim 19, further comprising:
sending to a group of the client devices coupled to the real-time communication session, by the one or more computing devices, an indication that indicates real-time communication has been disabled between the first client device and the second client device, wherein the group of the client devices does not include the first client device.

29. The method of claim 19, further comprising:
determining, by the one or more computing devices, whether the request received from the first client device comprises an identifier that identifies the real-time communication session, wherein the identifier is associated with the real-time communication session;
when the request comprises the identifier, determining, by the one or more computing devices and based in part on the request, whether the identifier was accessed by the first client device from a remote computing device that is not authorized to share the identifier; and
when the identifier was accessed from the remote computing device that is not authorized to share the identifier, disallowing, by the one or more computing devices, the first client device from coupling to the real-time communication session.

30. A system, comprising:
one or more processors;
a server module executable by the one or more processors to:
send a plurality of video feeds for display at a plurality of graphical user interfaces (GUIs) of client devices coupled to a real-time communication session, wherein the real-time communication session enables communication among a plurality of users associated with the client devices, and wherein at least one of the plurality of video feeds comprises a visual representation of user participation in the real-time communication session;
receive a request from a first client device to couple to the real-time communication session, wherein a first user is associated with the first client device; and
determine, in response to receiving the request, whether to enable communication using the real-time communication session between the first user and a second user associated with a second client device coupled to the real-time communication session.

31. The system of claim 30, wherein the server module is further executable by the one or more processors to:
determine whether a relationship exists between the first user and at least one user associated with at least one of the client devices coupled to the real-time communication session; and
send an indication of the relationship to at least one of the client devices coupled to the real-time communication session when the relationship exists between the first user and the at least one user.

32. The system of claim 30, wherein the server module is further executable by the one or more processors to:
receive a group of indications from the client devices coupled to the real-time communication session, wherein the indications indicate whether the first user is allowed to communicate using the real-time communication session; and
disallow the first client device from coupling to the real-time communication session when a quantity of indicators of the group of indicators that indicate the first user is not allowed to communicate using the real-time communications session is greater than a defined value.
